(19) United States
(12) Patent Application Publication
(10) Pub. No.: US 2026/0166899 A1
(43) Pub. Date: Jun. 18, 2026

(54) RECORDING APPARATUS

(71) Applicant: SEIKO EPSON CORPORATION, Tokyo (JP)

(72) Inventors: Soshi OKAWA, SHIOJIRI-SHI (JP); Junya SHIBUYA, SHIOJIRI-SHI (JP)

(21) Appl. No.: 19/419,582

(22) Filed: Dec. 15, 2025

(30) Foreign Application Priority Data
Dec. 16, 2024 (JP) 2024-220165

(51) Int. Cl. B41J 25/00; B41J 25/316; B41J 29/13; B41J 29/38

(52) U.S. Cl. CPC B41J 25/001; B41J 25/316; B41J 29/13; B41J 29/38

(57) ABSTRACT

A guide frame includes a first guide section configured to guide a recording unit along a first axis and a second guide section located to be separated from the first guide section in a width direction, which is a direction intersecting a medium conveyance direction at a position facing a recording section, the second guide section guiding the recording unit along the first axis. The recording unit includes a first guided section guided by the first guide section and a second guided section guided by the second guide section, and the second guided section also serves as a rotation mechanism configured to rotate the recording unit with the first guide section as a fulcrum when viewed from the first axis.

The present application is based on, and claims priority from JP Application Serial Number 2024-220165, filed Dec. 16, 2024, the disclosure of which is hereby incorporated by reference herein in its entirety.

### BACKGROUND

### 1. Technical Field

The present disclosure relates to a recording apparatus that performs recording on a medium.

### 2. Related Art

In a recording apparatus represented by a printer, as disclosed in JP-A-2001-146057, a posture of a head guide can be adjusted by a posture control mechanism and a posture of a recording head with respect to paper is made appropriate.

JP-A-2001-146057 is an example of the related art.

In the recording apparatus represented by the printer, the recording head is sometimes configured to be movable in an adjustment direction of a platen gap. The platen gap is a gap between a platen, which supports the paper at a position facing the recording head, and the recording head. When a mechanism for adjusting the posture of the recording head is provided while the recording head being configured to be movable in the adjustment direction of the platen gap, the cost and size of the apparatus are likely to be increased.

### SUMMARY

According to an aspect of the present disclosure, there is provided a recording apparatus including: a recording unit including a recording section configured to perform recording on a medium; a facing section facing the recording section; and a guide frame configured to guide the recording unit along a first axis including a direction in which an interval between the recording section and the facing section changes, wherein the guide frame includes: a first guide section configured to guide the recording unit along the first axis; and a second guide section located to be separated from the first guide section in a width direction, which is a direction intersecting a medium conveyance direction at a position facing the recording section, the second guide section guiding the recording unit along the first axis, the recording unit includes: a first guided section guided by the first guide section; and a second guided section guided by the second guide section, and the second guided section also serves as a rotation mechanism configured to rotate the recording unit with the first guide section as a fulcrum when viewed from the first axis.

### BRIEF DESCRIPTION OF THE DRAWINGS

FIG. 1 is an exterior perspective view of a printer.

FIG. 2 is a diagram illustrating an entire medium conveyance path of the printer.

FIG. 3 is a diagram of a state in which a discharge tray is opened and an adjustment dial is exposed.

FIG. 4 is a perspective view of a guide frame and a recording unit.

FIG. 5 is a plan view of the guide frame and the recording unit.

FIG. 6 is an enlarged view of a second guide section and the periphery thereof in FIG. 5.

FIG. 7 is an enlarged view of a first guide section and the periphery thereof in FIG. 5.

FIG. 8 is a cross-sectional perspective view of a first guided section.

FIG. 9 is a cross-sectional perspective view of a second guided section.

FIG. 10 is a cross-sectional view of the first guided section.

FIG. 11 is a cross-sectional view of the second guided section.

FIG. 12 is a perspective view of a worm wheel mechanism.

FIG. 13 is a perspective view of a rotation restriction member.

FIG. 14 is a cross-sectional perspective view of the worm wheel mechanism and is a diagram of a state in which the adjustment dial is present at a restriction position.

FIG. 15 is a cross-sectional perspective view of the worm wheel mechanism and is a diagram of a state in which the adjustment dial is present at a restriction release position.

### DESCRIPTION OF EMBODIMENTS

The present disclosure is schematically explained below.

A recording apparatus according to a first aspect includes: a recording unit including a recording section configured to perform recording on a medium; a facing section facing the recording section; and a guide frame configured to guide the recording unit along a first axis including a direction in which an interval between the recording section and the facing section changes. The guide frame includes: a first guide section configured to guide the recording unit along the first axis; and a second guide section located to be separated from the first guide section in a width direction, which is a direction intersecting a medium conveyance direction at a position facing the recording section, the second guide section guiding the recording unit along the first axis, the recording unit includes: a first guided section guided by the first guide section; and a second guided section guided by the second guide section, and the second guided section also serves as a rotation mechanism configured to rotate the recording unit with the first guide section as a fulcrum when viewed from the first axis.

Hereinafter, for convenience, an interval between the recording section and the facing section is referred to as platen gap. According to this aspect, since the second guided section includes the rotation mechanism that rotates the recording unit with the first guide section as the fulcrum when viewed from the first axis, it is possible to adjust the tilt of the recording section with respect to the medium conveyance direction.

According to this aspect, since the second guided section also serves as the rotation mechanism that rotates the recording unit with the first guide section as the fulcrum when viewed from the first axis, a part of a mechanism that enables the recording unit to move in an adjustment direction of the platen gap is used as a mechanism that adjusts the posture of the recording unit, and it is possible to prevent an increase in cost and the size of the apparatus.

A second aspect is an aspect dependent from the first aspect, wherein the second guided section has a configuration in which the second guide section is sandwiched by a first contact section and a second contact section in the medium conveyance direction, the second contact section includes an eccentric cam, and, when the eccentric cam rotates, the recording unit rotates when viewed from the first axis.

According to this aspect, since the second contact section includes the eccentric cam and the eccentric cam rotates, whereby the recording unit rotates when viewed from the first axis, the rotation mechanism can be obtained with a simple configuration.

A third aspect is an aspect dependent from the second aspect, wherein the rotation mechanism includes: the eccentric cam; a worm wheel provided integrally with the eccentric cam; and a worm configuring a worm gear mechanism in conjunction with the worm wheel.

According to this aspect, it is possible to obtain a large reduction ratio with the worm gear mechanism. That is, it is possible to reduce a rotation amount of the eccentric cam at the time when the worm is rotated and appropriately adjust the posture of the recording unit.

A self-lock function of the worm gear mechanism makes it difficult for the posture of the recording unit to fluctuate and it is possible to maintain an appropriate posture of the recording unit.

A fourth aspect is an aspect dependent from the third aspect, the recording apparatus including an adjustment dial configured to engage with the worm, wherein the worm rotates when the adjustment dial is rotated.

According to this aspect, since the recording apparatus includes the adjustment dial that engages with the worm and the worm is rotated when the adjustment dial is rotated, it is possible to easily rotate the worm.

A fifth aspect is an aspect dependent from the fourth aspect, wherein the adjustment dial has a driver fitting shape.

According to this aspect, since the adjustment dial has the driver fitting shape, it is possible to more easily rotate the adjustment dial, that is, the worm. Even if the adjustment dial is reduced in size, since the adjustment dial can be easily rotated, it is possible to achieve a reduction in the size of the apparatus. Since the adjustment dial can be easily rotated even if the adjustment dial is disposed in a place that the user's fingers cannot reach, the degree of freedom in disposing the adjustment dial is improved.

A sixth aspect is an aspect dependent from the fifth aspect, the recording apparatus including: a rotation restriction member configured to restrict rotation of the worm; and a pressing member configured to press the adjustment dial toward the rotation restriction member, wherein the adjustment dial is displaceable to a restriction position where rotation is restricted by the rotation restriction member and a restriction release position where the restriction is released, and the adjustment dial is displaced from the restriction position to the restriction release position when the adjustment dial present at the restriction position is pushed in against a pressing force of the pressing member.

According to this aspect, since the adjustment dial is displaceable to the restriction position where the rotation is restricted and the restriction release position where the restriction is released, it is possible to rotate the adjustment dial at the restriction release position and therefor it is possible to rotate the recording unit.

At the restriction position, since the rotation of the adjustment dial is restricted and the rotation of the worm is restricted, it is possible to prevent the posture of the recording unit from fluctuating and it is possible to maintain an appropriate posture of the recording unit.

Note that this aspect may be dependent from not only the fifth aspect but also the fourth aspect.

A seventh aspect is an aspect dependent from the fourth aspect, the recording apparatus including, in an apparatus upper part, a discharge tray configured to receive a medium discharged after recording is performed thereon, wherein the discharge tray is openable and closable or detachable, and the adjustment dial is exposed by opening or detaching the discharge tray.

According to this aspect, since the adjustment dial is exposed by opening or detaching the discharge tray, it is possible to easily access the adjustment dial and, as a result, it is possible to easily rotate the recording unit.

Note that this aspect may be dependent from not only the fourth aspect but also the fifth or sixth aspect.

An eighth aspect is an aspect dependent from the third aspect, wherein a toothless section is provided in the worm wheel, and a rotation range of the worm wheel is restricted by the toothless section.

According to this aspect, since the toothless section is provided in the worm wheel and a rotation range of the worm wheel is restricted by the toothless section, a rotation range of the recording unit is restricted. Accordingly, it is possible to prevent the recording unit from rotating more than expected and prevent deficiencies such as breakage from occurring.

Note that this aspect may be dependent from not only the third aspect but also any one of the fourth to seventh aspects.

A ninth aspect is an aspect dependent from the second aspect, wherein the first guided section has a configuration of sandwiching the first guide section in the medium conveyance direction and the two first guided sections are provided at an interval along the first axis, and the one second guided section is provided.

According to this aspect, since the first guided section has the configuration of sandwiching the first guide section in the medium conveyance direction and the two first guided sections are provided at an interval along the first axis and the one second guided section is provided, the posture of the guide frame is stabilized when the recording unit moves along the first axis.

Note that this aspect may be dependent from not only the second aspect but also any one of the third to eighth aspects.

The present disclosure is specifically explained below.

An inkjet printer 1 is explained below as an example of a recording apparatus that performs recording on a medium. The inkjet printer 1 is hereinafter simply referred to as printer 1.

An X-Y-Z coordinate system illustrated in the figures is an orthogonal coordinate system in which a direction in which an arrow faces is a + direction and a direction opposite to the direction is a − direction. An X-axis direction is an apparatus width direction and is a width direction of a medium on which recording is performed. When viewed from an operator of the printer 1, a +X direction is the left side and a −X direction is the right side. Hereinafter, the X-axis direction is sometimes referred to as medium width direction or simply referred to as width direction.

A Y-axis direction is an apparatus depth direction and is a direction along a medium conveyance direction at recording time. A +Y direction is a direction from the back to the front of the apparatus and a −Y direction is a direction from the front to the back of the apparatus. In the present embodiment, among side surfaces forming the periphery of the printer 1, the side surface in the +Y direction is an apparatus front surface and the side surface in the −Y direction is an apparatus back surface.

A Z-axis direction is a direction along the vertical direction and is an apparatus height direction. A +Z direction is the vertically upward direction and a −Z direction is the vertically downward direction. The Z-axis direction is an example of a first axis including a direction in which a platen gap explained below changes.

In the following explanation, a direction in which a medium is conveyed is sometimes referred to as “downstream” and a direction opposite to the direction is sometimes referred as “upstream”.

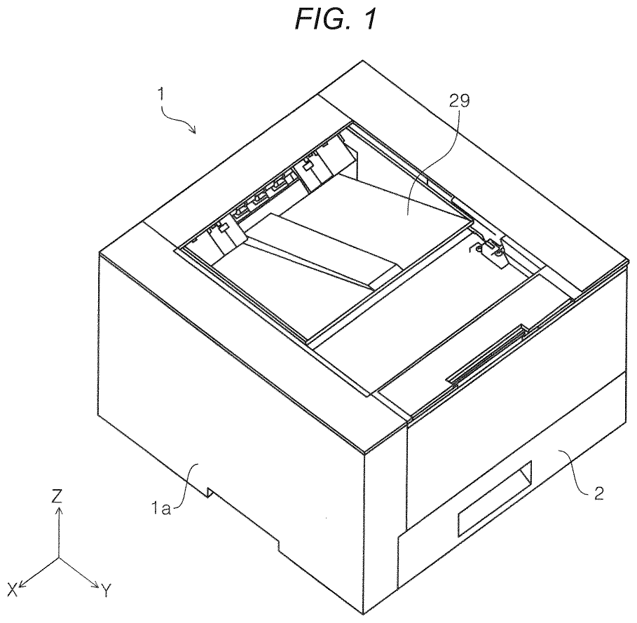

In FIG. 1, the printer 1 includes a medium storage cassette 2 in a lower part of a main body 1a. A discharge tray 29 is provided in an upper part of the main body 1a.

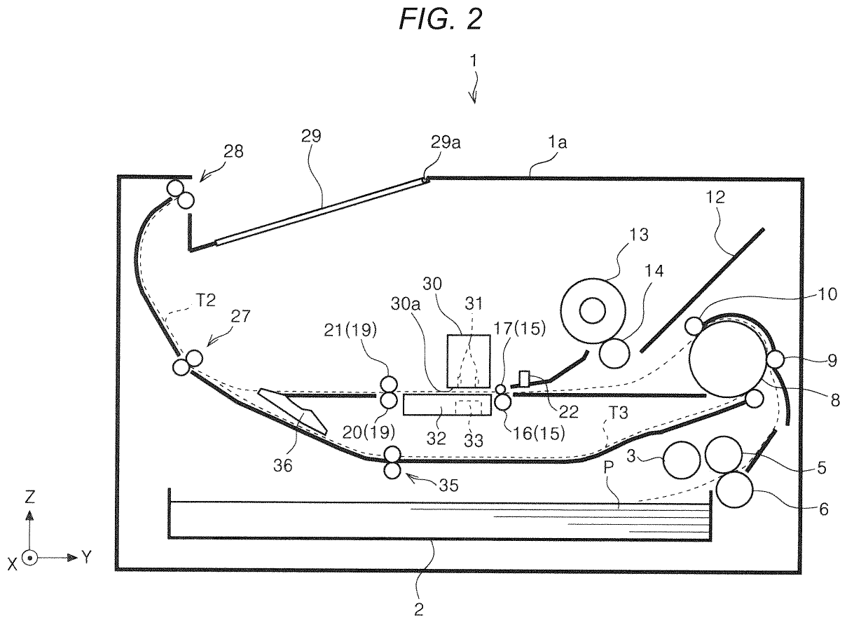

A medium conveyance path of the printer 1 is explained below with reference to FIG. 2. In FIG. 2, the medium conveyance path is indicated by a broken line.

Reference sign P denotes media stored in the medium storage cassette 2. An example of the media is recording paper. The medium storage cassette 2 is provided to be detachably attachable from the apparatus front side.

A pickup roller 3 driven by a not-illustrated motor is provided above the medium storage cassette 2. The pickup roller 3 is capable of advancing to and retracting from the media stored in the medium storage cassette 2 and rotates while being in contact with the media stored in the medium storage cassette 2 to feed the media from the medium storage cassette 2 in the +Y direction.

A feed roller 5 driven by a not-illustrated motor and a separation roller 6, to which rotational torque is applied by a not-illustrated torque limiter, are provided downstream with respect to the medium storage cassette 2. The media fed from the medium storage cassette 2 are nipped by the feed roller 5 and the separation roller 6 to be separated and a separated medium is further fed downstream.

A reverse roller 8 driven by a not-illustrated motor is provided downstream of the feed roller 5 and the separation roller 6. A first nip roller 9 and a second nip roller 10 are provided around the reverse roller 8. The medium is nipped by the reverse roller 8 and the first nip roller 9, further nipped by the reverse roller 8 and the second nip roller 10, and conveyed. A conveyance direction of the medium is reversed from the +Y direction to the −Y direction by the reverse roller 8, and the medium is conveyed downstream.

Note that the printer 1 includes a medium feed path from a medium placing section 12 in addition to a medium feed path from the medium storage cassette 2. The medium placing section 12 supports the medium in an inclining posture, and the supported medium is conveyed to a first conveyance roller pair 15 by a feed roller 13 driven by a not-illustrated motor. Reference numeral 14 denotes a separation roller to which rotational torque is applied by a not-illustrated torque limiter.

The first conveyance roller pair 15 including a driving roller 16 driven by a not-illustrated motor and a driven roller 17 capable of rotating following the driving roller 16 is provided downstream of the reverse roller 8. The driven roller 17 is pressed toward the driving roller 16 by a not-illustrated pressing member.

A line head 30 configures a recording section that performs recording on the medium. The line head 30 is an example of a recording head that ejects ink, which is an example of liquid, onto the medium and performs recording on the medium. The line head 30 is a liquid ejection head in which a plurality of nozzle 31, which eject ink, are arrayed to cover an entire region in the medium width direction. The line head 30 is configured as a liquid ejection head that is long in the medium width direction and is capable of performing recording in an entire medium width region without involving movement in the medium width direction.

Reference sign 30a denotes a head surface that is a surface facing the medium. The head surface 30a can also be referred to as liquid ejecting surface or nozzle surface. The head surface 30a is parallel to the medium conveyance direction, that is, the Y-axis direction at a position facing the line head 30. The head surface 30a is parallel to an X-Y plane.

The printer 1 includes a not-illustrated ink storage section. The ink ejected from the line head 30 is supplied from the ink storage section to the line head 30 via a not-illustrated ink tube.

Instead of the line head 30, a recording head that performs recording on the medium while moving along the medium width direction may be adopted. The recording section is not limited to a scheme of performing recording on a medium by ejecting ink and may include a recording head of a dot impact scheme or another scheme.

A facing section 32 is provided at a position facing the head surface 30a of the line head 30. The facing section may also be referred to as platen. The facing section 32 according to the present embodiment includes an openable and closable shutter (not illustrated). The facing section 32 supports the medium in a state in which the shutter is closed. A gap between the facing section 32 and the head surface 30a is hereinafter referred to as platen gap. The line head 30 is provided to be movable in a direction in which the line head 30 advances to and retracts from the facing section 32, that is, an adjustment direction of the platen gap. In the present embodiment, the adjustment direction of the platen gap is parallel to the Z-axis direction. Hereinafter, the line head 30 moving in the +Z-axis direction is sometimes referred to as “raise” and the line head 30 moving in the −Z direction is sometimes referred to as “fall”.

A cap section 33 is provided the lower side of the shutter. When the shutter opens, the cap section 33 and the head surface 30a can face each other. The line head 30 is provided to be capable of rising and falling with the power of a not-illustrated motor. The cap section 33 can cover the head surface 30a when the line head 30 falls in a state in which the shutter is opened.

A second conveyance roller pair 19 including a driving roller 20, which is driven by a not-illustrated motor, and a driven roller 21, which is capable of rotating following the driving roller 20, is provided downstream of the line head 30. The medium on which recording has been performed is conveyed downstream by the second conveyance roller pair 19.

The driven roller 21 is pressed toward the driving roller 20 by a not-illustrated pressing member.

A third conveyance roller pair 27 is provided downstream of the second conveyance roller pair 19. A discharge roller pair 28 is further provided downstream of the third conveyance roller pair 27. A path between the third conveyance roller pair 27 and the discharge roller pair 28 is configured as a face-down discharge path T2. The medium on which recording has been performed is discharged to the discharge tray 29 by the discharge roller pair 28 in a state in which the most recently recorded surface is faced down.

The discharge tray 29 is provided to be openable and closable by rotating centering on a turning shaft 29a with respect to the main body 1a of the printer 1. The axis center line of the turning shaft 29a is parallel to the X axis. The user is capable of accessing the inside of the printer 1 by opening the discharge tray 29.

The discharge tray 29 may be detachably provided instead of being provided to be openable and closable.

A flap 36 is provided between the second conveyance roller pair 19 and the third conveyance roller pair 27. The third conveyance roller pair 27 and the discharge roller pair 28 can be reversed. The medium can be fed to a reversal path T3 by reversely rotating the third conveyance roller pair 27 and the discharge roller pair 28 in a state in which the trailing end of the medium is located between the flap 36 and the third conveyance roller pair 27.

A fourth conveyance roller pair 35 is provided in the reversal path T3, and the medium fed to the inversion path T3 is fed to the reverse roller 8. By providing such the reversal path T3, recording can be performed on both surfaces of the medium.

Subsequently, a mechanism for raising and lowering the line head 30 and a mechanism for rotating the line head 30 when viewed in the Z-axis direction are explained.

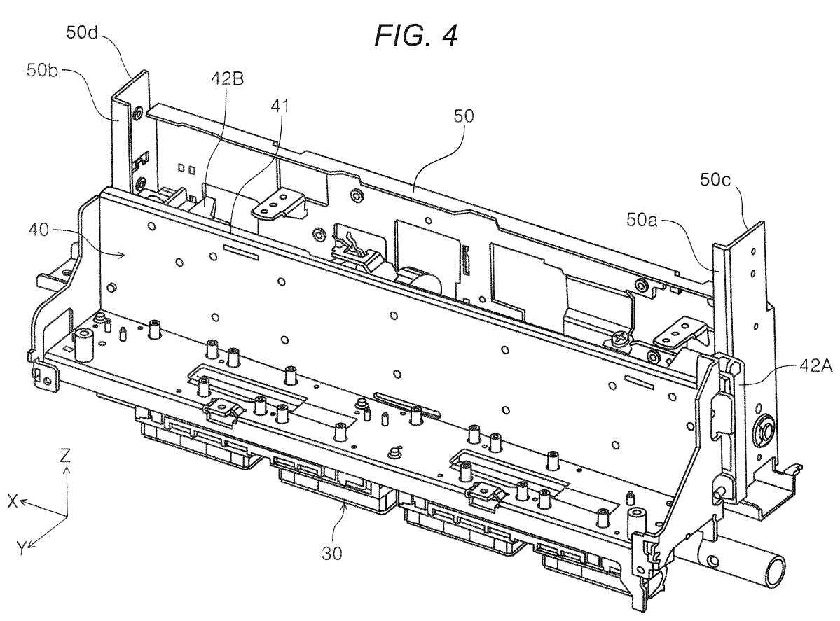

In FIG. 4, reference numeral 50 denotes a guide frame configuring a base of the main body 1a. The guide frame 50 is formed by bending a metal plate material and includes a first guide section 50a and a first side frame section 50c at the end portion in the −X direction and includes a second guide section 50b and a second side frame section 50d at the end portion in the +X direction. The first guide section 50a and the second guide section 50b are plate-shaped parts forming surfaces parallel to the X-Z plane and extend in the Z-axis direction. The first side frame section 50c and the second side frame section 50d are plate-shaped parts forming surfaces parallel to the Y-Z plane and extend in the Z-axis direction. The second guide section 50b is located to be separated from the first guide section 50a in the X-axis direction, that is, the width direction.

The first guide section 50a is formed to be bent in the +X direction from the +Y direction end portion of the first side frame section 50c. The second guide section 50b is formed to be bent in the −X direction from the +Y direction end portion of the second side frame section 50d.

Reference numeral 40 denotes a recording unit including the line head 30. The recording unit 40 includes the line head 30 in a unit frame 41. The unit frame 41 is formed by bending a metal plate material like the guide frame 50.

In the unit frame 41, on the surface in the −Y direction, a rack member 42A is provided at the end portion in the −X direction and a rack member 42B is provided at the end portion in the +X direction.

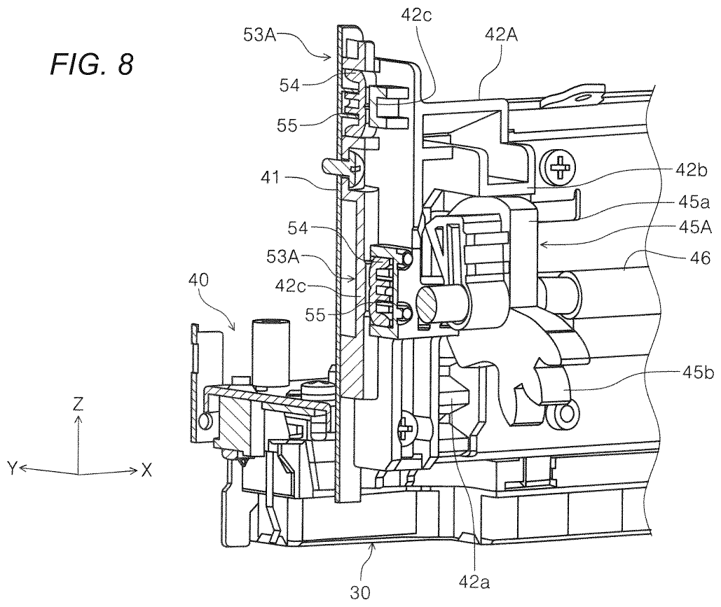

In the rack member 42A, as illustrated in FIG. 8, a rack section 42a is formed in the Z-axis direction. A supported section 42b is formed in the rack member 42A to protrude in the −Y direction.

A shaft 46 extending in the X-axis direction is provided in the −Y direction with respect to the guide frame 50. The shaft 46 is driven by a not-illustrated motor. As illustrated in FIG. 8, a rotating member 45A is provided at the −X direction end portion of the shaft 46. The rotating member 45A includes a cam section 45a and a pinion section 45b. The cam section 45a supports the supported section 42b of the rack member 42A. The outer periphery of the cam section 45a is formed such that the diameter thereof changes in the peripheral direction. Accordingly, when the rotating member 45A rotates, the Z-axis direction position of the supported section 42b changes. Accordingly, the platen gap changes.

For example, if the position of the line head 30 in performing recording on plain paper is represented as a first recording position, when recording is performed on special paper thicker than the plain paper, the line head 30 is positioned at a second recording position higher than the first recording position. The cam section 45a specifies the recording position of the line head 30 in this way.

A movement region of the line head 30 includes a jam processing position that is a position where the line head 30 rises most. The pinion section 45b meshes with the rack section 42a and configures a rack and pinion mechanism. When the cam section 45a coms off from the supported section 42b according to the rotation of the rotating member 45A, the cam section 45a moves to a meshing region of the pinion section 45b and the rack section 42a. Accordingly, the line head 30 can rise to the jam processing position. When the line head 30 rises to the jam processing position, the platen gap becomes the widest. Accordingly, when jam occurs, a jammed medium can be removed. The jam processing can be executed by opening the discharge tray 29 explained above.

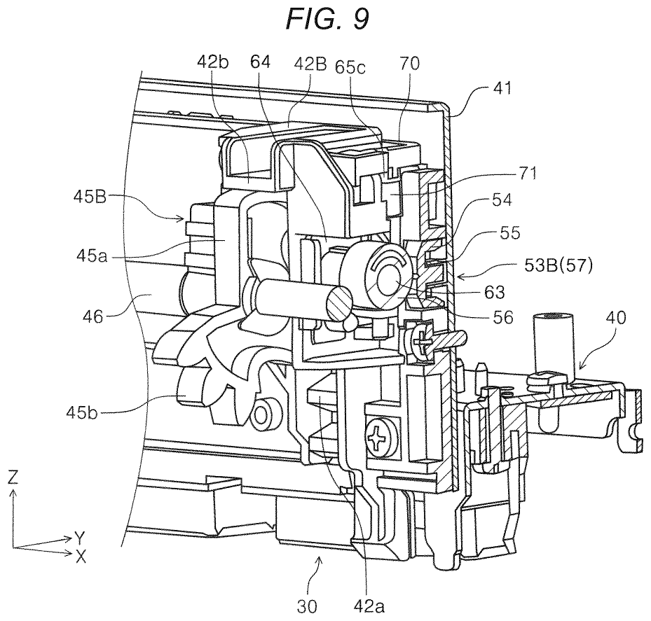

As illustrated in FIG. 9, a rotating member 45B that is the same as the rotating member 45A is also provided at the end portion in the +X direction. Like the rotating member 45A, the rotating member 45B includes the cam section 45a and the pinion section 45b. Like the rack member 42A, the rack member 42B includes the supported section 42b and the rack section 42a.

As explained above, the recording unit 40 is supported by the cam sections 45a or the pinion sections 45b at both end portions in the X axis direction.

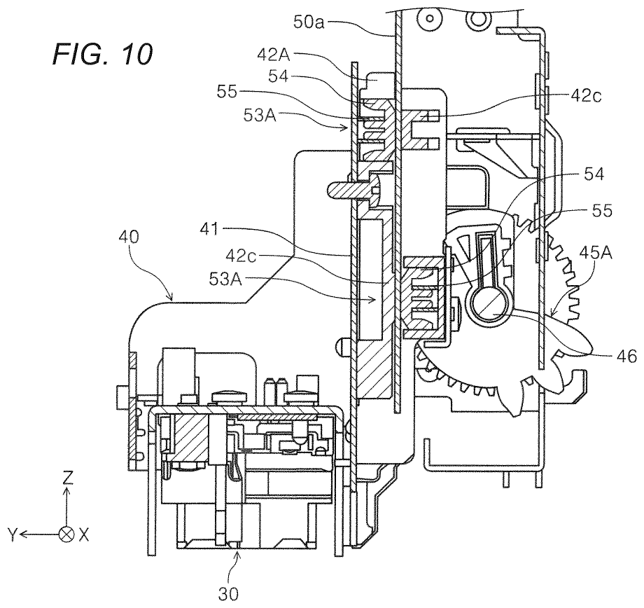

Subsequently, as illustrated in FIGS. 8 and 10, the recording unit 40 includes a first guided section 53A. The first guided section 53A is a part guided in the Z-axis direction by the first guide section 50a. In FIG. 8, illustration of the first guide section 53a is omitted.

The first guided section 53A has a configuration of sandwiching the first guide section 50a in the Y-axis direction and two first guided sections 53A are provided at an interval along the Z axis.

More specifically, the first guided section 53A has a configuration in which the first guide section 50a is sandwiched by a slide section 42c formed in the rack member 42A and a slider 54 provided in the rack member 42A.

In the rack member 42A, the slider 54 is held to be displaceable in a direction of advancing and retracting with respect to the first guide section 50a, that is, in the Y-axis direction and is pressed toward the first guide section 50a by a coil spring 55, which is an example of a pressing member. In the first guided section 53A provided most in the +Z direction, the slider 54 is provided in the +Y direction with respect to the first guide section 50a and the slide section 42c is provided in the −Y direction with respect to the first guide section 50a. In the first guided section 53A provided most in the −Z direction, the slider 54 is provided in the −Y direction with respect to the first guide section 50a and the slide section 42c is provided in the +Y direction with respect to the first guide section 50a.

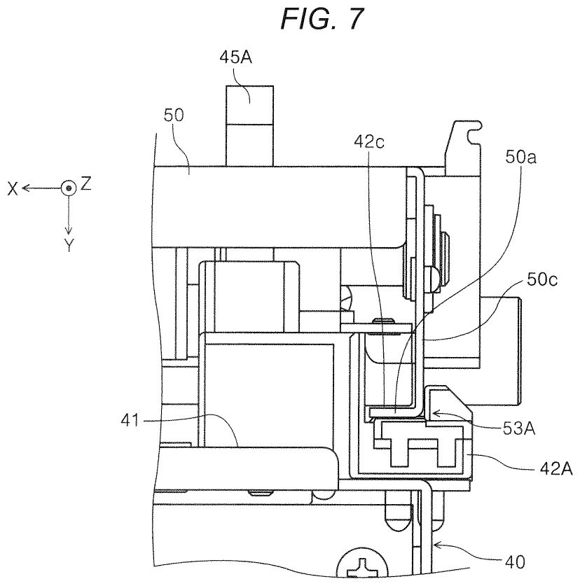

As illustrated in FIG. 7, the rack member 42A has a shape of sandwiching the first side frame section 50c in the X-axis direction. Accordingly, the position in the X axis direction of the recording unit 40 is restricted.

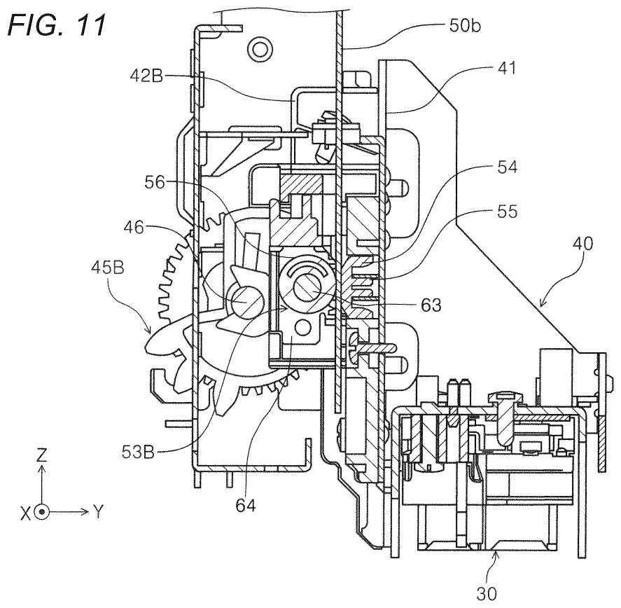

Subsequently, as illustrated in FIGS. 9 and 11, the recording unit 40 includes a second guided section 53B. The second guided section 53B is a part guided in the Z-axis direction by the second guide section 50b. In FIG. 9, illustration of the second guide section 50b is omitted.

The second guided section 53B has a configuration of sandwiching the second guide section 50b in the Y-axis direction and one second guided section 53B is provided in the Z-axis direction.

More specifically, the second guided section 53B has a configuration in which the second guide section 50b is sandwiched by the slider 54 and an eccentric cam 56 provided in the rack member 42B. The slider 54 is an example of a first contact section and the eccentric cam 56 is an example of a second contact section.

In the rack member 42B, the slider 54 is held to be displaceable in a direction of advancing and retracting with respect to the second guide section 50b, that is, the Y-axis direction and is pressed toward the second guide section 50b by the coil spring 55, which is an example of a pressing member. The slider 54 is provided in the +Y direction with respect to the second guide section 50b. The eccentric cam 56 is provided in the −Y direction with respect to the second guide section 50b.

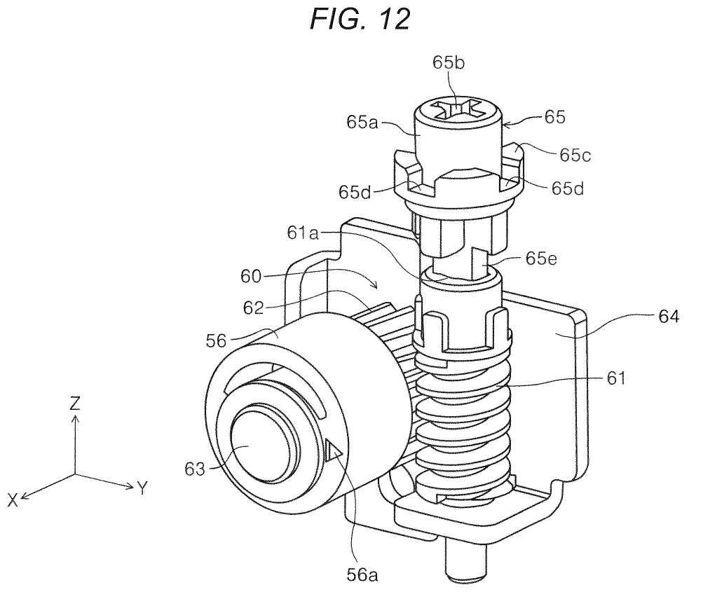

A worm gear mechanism 60 illustrated in FIG. 12 is provided in the rack member 42B. The worm gear mechanism 60 includes a worm 61 and a worm wheel 62 in a support frame 64. The support frame 64 is provided on the rack member 42B.

The eccentric cam 56 rotates integrally with the worm wheel 62 centering on a support shaft 63 provided on the support frame 64. The axial center line of the support shaft 63 is parallel to the X axis.

The worm 61 is rotatably provided in the support frame 64. The rotation axis center line of the worm 61 is parallel to the Z axis. The worm 61 meshes with the worm wheel 62. The worm wheel 62 rotates according to the rotation of the worm 61, that is, the eccentric cam 56 rotates.

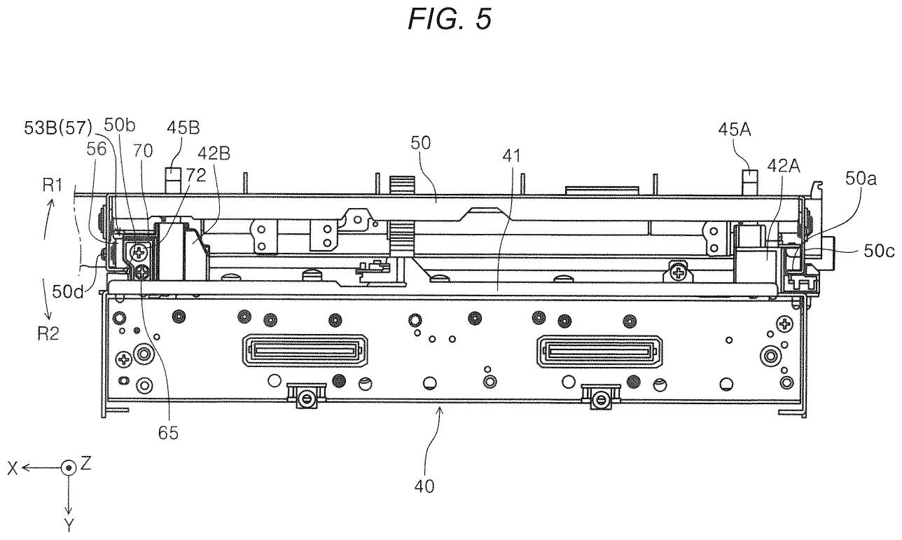

When the eccentric cam 56 rotates, the recording unit 40 rotates with the first guide section 50a as a fulcrum when viewed from the Z axis as indicated by arrows R1 and R2 in FIG. 5. Accordingly, the posture, that is, the tilt of the line head 30 with respect to the medium conveyance direction can be adjusted and recording quality can be adjusted.

As explained above, the eccentric cam 56 configures a rotation mechanism 57 that rotates the recording unit 40 with the first guide section 50a as a fulcrum when viewed from the Z axis. That is, the second guided section 53B also serves as the rotation mechanism 57 that rotates the recording unit 40 with the first guide section 50a as a fulcrum when viewed from the Z axis.

In order to allow such rotation of the recording unit 40, play is formed between the rack member 42B and the first side frame section 50c in a part (refer to FIG. 7) in which the rack member 42B sandwiches the first side frame section 50c.

Subsequently, as illustrated in FIG. 12, a fitting hole 61a is formed at the upper end portion of the worm 61. A protrusion-like fitting section 65e formed at the lower end portion of an adjustment dial 65 fits in the fitting hole 61a. Accordingly, when the adjustment dial 65 is rotated, the worm 61 rotates and the eccentric cam 56 rotates. The fitting section 65e is displaceable in the Z-axis direction with respect to the fitting hole 61a.

The adjustment dial 65 includes a cylindrical section 65a at an upper portion thereof. A driver fitting hole 65b serving as a driver fitting shape is formed in the cylindrical section 65a to be able to fit with a plus driver.

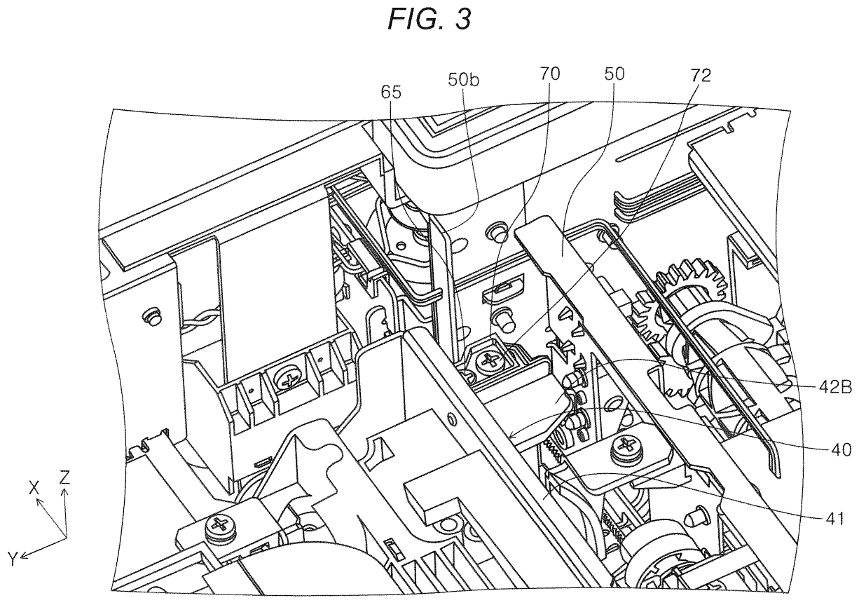

The adjustment dial 65 is exposed as illustrated in FIG. 3 when the discharge tray 29 (see FIGS. 1 and 2) is opened. That is, by opening the discharge tray 29, the adjustment dial 65 can be rotated and the recording unit 40 can be rotated.

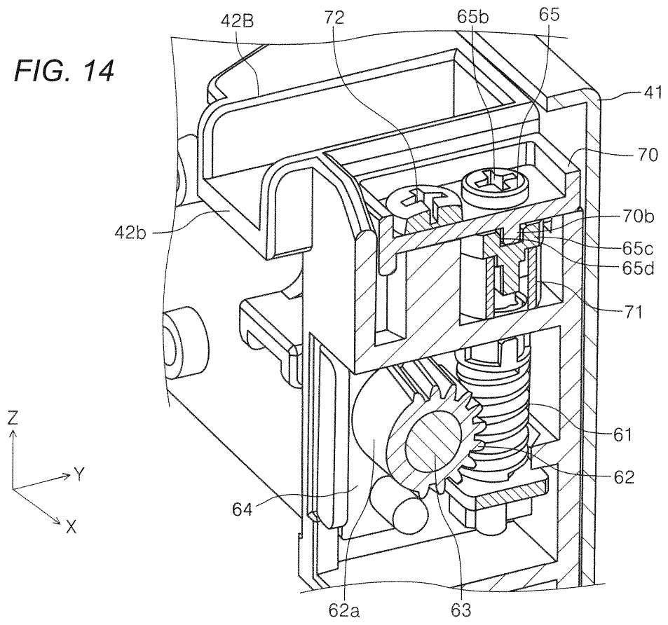

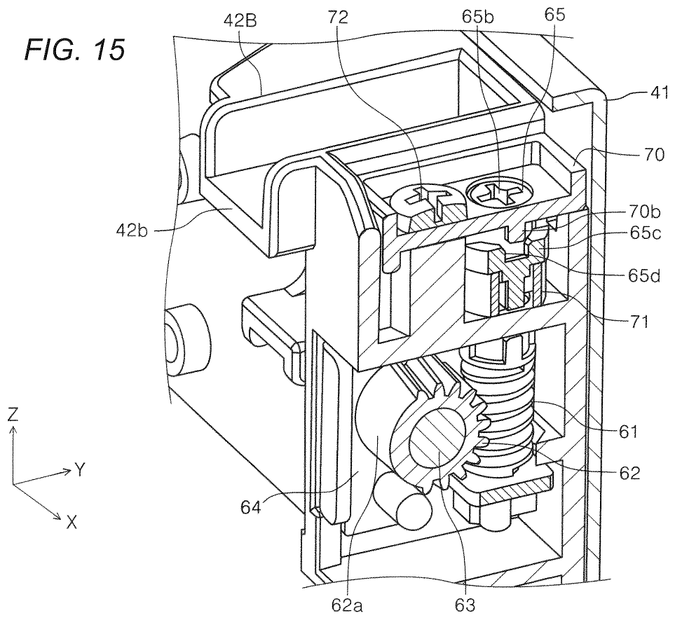

Subsequently, as illustrated in FIGS. 14 and 15, a rotation restriction member 70 is engaged with the adjustment dial 65. The rotation restriction member 70 is fixed to the rack member 42B by a screw 72.

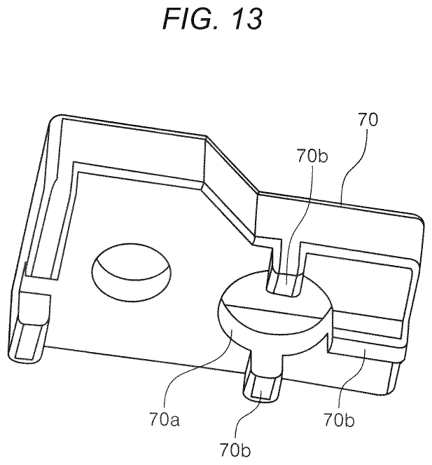

As illustrated in FIG. 13, a hole 70a is formed in the rotation restriction member 70. The cylindrical section 65a of the adjustment dial 65 is exposed in the +Z direction via the hole 70a.

A protrusion 70b is formed on the lower side of the rotation restriction member 70. The plurality of protrusions 70b are provided at intervals of 90° in a rotation direction of the adjustment dial 65. However, such disposition of the protrusions 70b is an example and is not limited thereto. Only one protrusion 70b may be provided.

As illustrated in FIG. 12, a restricted section 65c is formed in the adjustment dial 65. The restricted section 65c is a part larger in a diameter than the cylindrical section 65a. A plurality of recesses 65d are formed in the circumferential direction. The protrusions 70b formed in the rotation restriction member 70 can be fit in the recesses 65d. All of the protrusions 70b can be simultaneously fit in the recesses 65d respectively corresponding thereto.

In FIGS. 14 and 15, the adjustment dial 65 is provided to be displaceable in the Z-axis direction and is pressed in the +Z direction by a coil spring 71, which is an example of a pressing member. Accordingly, it is possible to maintain a state in which the protrusions 70b of the rotation restriction member 70 are fit in the recesses 65d of the adjustment dial 65. As illustrated in FIG. 14, in a state in which the protrusions 70b of the rotation restriction member 70 is fit in the recesses 65d of the adjustment dial 65, the adjustment dial 65 cannot rotate and the tilt of the recording unit 40 is maintained. This position is a restriction position where the rotation of the adjustment dial 65 is restricted by the rotation restriction member 70.

When the adjustment dial 65 is rotated, the adjustment dial 65 is pushed in the −Z direction by the tip of the driver. Accordingly, as illustrated in FIG. 15, the fitting of the recesses 65d of the adjustment dial 65 and the protrusions 70b of the rotation restriction member 70 is released and the adjustment dial 65 can be rotated. The position of the adjustment dial 65 in FIG. 15 is a restriction release position where the restriction of the rotation of the adjustment dial 65 is released by the rotation restriction member 70.

Action effects of the printer 1 having the configuration explained above are explained below.

The guide frame 50 includes the first guide section 50a and the second guide section 50b that guide the recording unit 40 along the Z axis. The recording unit 40 includes the first guided section 53A guided by the first guide section 50a and the second guided section 53B guided by the second guide section 50b.

The second guided section 53B also serves as the rotation mechanism 57 that rotates the recording unit 40 with the first guide section 50a as a fulcrum when viewed from the Z axis. Therefore, a part of the mechanism that enables the recording unit 40 to move in the adjustment direction of the platen gap is used as a mechanism that adjusts the posture of the recording unit 40. It is possible to prevent an increase in the cost and the size of the apparatus.

The second guided section 53B has a configuration in which the second guide section 50b is sandwiched by the slider 54 and the eccentric cam 56 in the Y-axis direction, that is, the medium conveyance direction. The eccentric cam 56 rotates, whereby the recording unit 40 rotates when viewed from the Z axis. Therefore, the rotation mechanism 57 can be obtained with a simple configuration.

The rotation mechanism 57 includes the eccentric cam 56, the worm wheel 62 provided integrally with the eccentric cam 56, and the worm 61 configuring the worm gear mechanism 60 in conjunction with the worm wheel 62. Therefore, since a large reduction ratio can be obtained by the worm gear mechanism 60 and a rotation amount of the eccentric cam 56 at the time when the worm 61 is rotated can be suppressed, it is possible to appropriately adjust the posture of the recording unit 40.

With the self-lock function of the worm gear mechanism 60, the posture of the recording unit 40 is less likely to fluctuate. It is possible to maintain an appropriate posture of the recording unit 40.

The rotation mechanism 57 includes the adjustment dial 65 that engages with the worm 61. The worm 61 is rotated by rotating the adjustment dial 65. Accordingly, it is possible to easily rotate the worm 61.

The adjustment dial 65 includes the driver fitting hole 65b serving as the driver fitting shape. Accordingly, the adjustment dial 65, that is, the worm 61 can be more easily rotated. Even if the adjustment dial 65 is reduced in size, the adjustment dial 65 can be easily rotated. Therefore, it is possible to achieve a reduction in the size of the apparatus. Since the adjustment dial 65 can be easily rotated even if the adjustment dial 65 is disposed in a place that the user's fingers cannot reach, a degree of freedom in disposing the adjustment dial 65 is improved.

The rotation mechanism 57 includes the rotation restriction member 70 that restricts the rotation of the worm 61 and the coil spring 71 serving as a pressing member that presses the adjustment dial 65 toward the rotation restriction member 70. The adjustment dial 65 is displaceable to the restriction position (FIG. 14) where rotation is restricted by the rotation restriction member 70 and the restriction release position (FIG. 15) where the restriction is released. When the adjustment dial 65 present at the restriction position is pushed in by the driver against the pressing force of the coil spring 71, the adjustment dial 65 is displaced from the restriction position to the restriction release position. As explained above, it is possible to rotate the adjustment dial 65 in the restriction release position and therefore it is possible to rotate the recording unit 40.

In the restriction position, since the rotation of the adjustment dial 65 is restricted and the rotation of the worm 61 is restricted, it is possible to prevent the posture of the recording unit 40 from fluctuating and it is possible to maintain an appropriate posture of the recording unit 40.

The printer 1 includes, in the apparatus upper part, the discharge tray 29 that receives the medium that is discharged after being recorded thereon. The discharge tray 29 is openable and closable and the adjustment dial 65 is exposed by opening the discharge tray 29. Accordingly, it is possible to easily access the adjustment dial 65 and, as a result, it is possible to easily rotate the recording unit 40.

As illustrated in FIGS. 14 and 15, a toothless section 62a is provided in the worm wheel 62. A rotation range of the worm wheel 62 is restricted by the toothless section 62a. Accordingly, it is possible to prevent the recording unit 40 from rotating more than expected and prevent problems such as deficiencies from occurring.

A mark 56a is provided in the eccentric cam 56 as illustrated in FIG. 12. In front view of the eccentric cam 56 from the +X direction, when the mark 56a is at a 3 o'clock position of a hand of a timepiece as illustrated in FIG. 12, this indicates that the recording unit 40 is present at the intermediate position of a rotatable range. Accordingly, the posture of the recording unit 40 can be visually grasped. In the present embodiment, the rotatable range of the eccentric cam 56 is smaller than 360°.

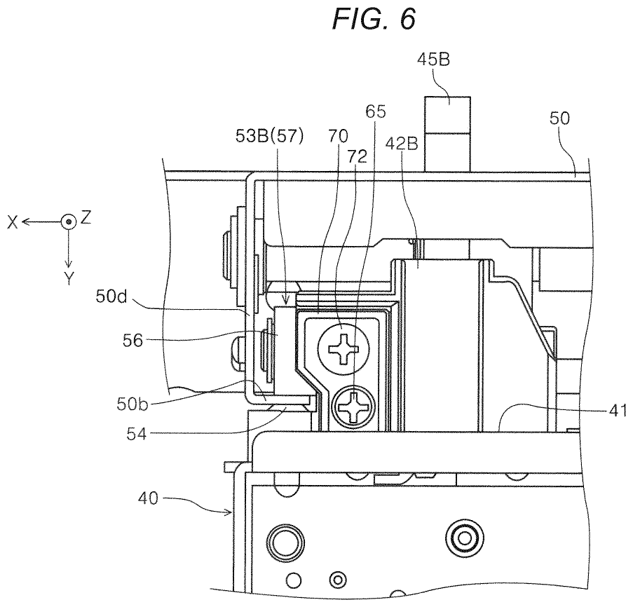

As illustrated in FIG. 6, a part of the eccentric cam 56 is exposed when viewed from the +Z direction. Therefore, it is also preferable to provide the mark 56a at a position visible when viewed from the +Z direction.

The first guided section 53A has a configuration of sandwiching the first guide section 50a in the medium conveyance direction and two first guided sections 53A are provided at an interval along the Z axis and one second guided section 53B is provided. Accordingly, the posture of the guide frame 50 is stabilized when the recording unit 40 moves along the Z axis.

The present disclosure is not limited to the embodiment and modified examples explained above and various modifications can be made within the scope of the disclosure set forth in the appended claims, and it is obvious that these modifications also fall within the scope of the present disclosure.

What is claimed is:

1. A recording apparatus comprising:
a recording unit including a recording section configured to perform recording on a medium;
a facing section facing the recording section; and
a guide frame configured to guide the recording unit along a first axis including a direction in which an interval between the recording section and the facing section changes, wherein
the guide frame includes:
a first guide section configured to guide the recording unit along the first axis; and
a second guide section located to be separated from the first guide section in a width direction, which is a direction intersecting a medium conveyance direction at a position facing the recording section, the second guide section guiding the recording unit along the first axis,
the recording unit includes:
a first guided section guided by the first guide section; and
a second guided section guided by the second guide section, and
the second guided section also serves as a rotation mechanism configured to rotate the recording unit with the first guide section as a fulcrum when viewed from the first axis.

2. The recording apparatus according to claim 1, wherein
the second guided section has a configuration in which the second guide section is sandwiched by a first contact section and a second contact section in the medium conveyance direction,
the second contact section includes an eccentric cam, and
when the eccentric cam rotates, the recording unit rotates when viewed from the first axis.

3. The recording apparatus according to claim 2, wherein the rotation mechanism includes:
the eccentric cam;
a worm wheel provided integrally with the eccentric cam; and
a worm configuring a worm gear mechanism in conjunction with the worm wheel.

4. The recording apparatus according to claim 3, comprising an adjustment dial configured to engage with the worm, wherein
the worm rotates when the adjustment dial is rotated.

5. The recording apparatus according to claim 4, wherein the adjustment dial has a driver fitting shape.

6. The recording apparatus according to claim 5, comprising:
a rotation restriction member configured to restrict rotation of the worm; and
a pressing member configured to press the adjustment dial toward the rotation restriction member, wherein
the adjustment dial is displaceable to a restriction position where rotation is restricted by the rotation restriction member and a restriction release position where the restriction is released, and
the adjustment dial is displaced from the restriction position to the restriction release position when the adjustment dial present at the restriction position is pushed in against a pressing force of the pressing member.

7. The recording apparatus according to claim 4, comprising, in an apparatus upper part, a discharge tray configured to receive a medium discharged after recording is performed thereon, wherein
the discharge tray is openable and closable or detachable, and
the adjustment dial is exposed by opening or detaching the discharge tray.

8. The recording apparatus according to claim 3, wherein
a toothless section is provided in the worm wheel, and
a rotation range of the worm wheel is restricted by the toothless section.

9. The recording apparatus according to claim 2, wherein
the first guided section has a configuration of sandwiching the first guide section in the medium conveyance direction and the two first guided sections are provided at an interval along the first axis, and
the one second guided section is provided.
